(19) United States
(12) Patent Application Publication
(10) Pub. No.: US 2003/0172824 A1
(43) Pub. Date: Sep. 18, 2003

(54) Short inking system for a rotary printing machine

(76) Inventor: Hans-Bernhard Bolza-Schunemann, Wurzburg (DE)

Correspondence Address: Douglas R Hanscom, Jones Tullar & Cooper, P O Box 2266, Eads Station, Arlington, VA, 22202, US

(21) Appl. No.: 10/275,278

(22) PCT Filed: May 12, 2001
(86) PCT No.: PCT/DE01/01816

(30) Foreign Application Priority Data
May 17, 2000 (DE) 100 23 935.8

(51) Int. Cl. B41F 31/00

(52) U.S. Cl. 101/350.1

(57) ABSTRACT

The invention relates to a short inking system for a rotary printing machine with a changeable machine glazing cylinder (05).

The invention relates to a short inking system of a rotary printing press in accordance with the preambles of claims 1, 2, 3 or 4.

WO 91/13761 A1 describes a short inking system of a rotary printing press in which the forme cylinder and the ink application roller have the same diameter. A traversing smoothing roller is assigned to the ink application roller.

The object of the invention is based on creating a short inking system for a rotary printing press.

In accordance with the invention, the object is attained by means of the characteristics of claims 1, 2, 3 or 4.

This short inking system without duct-adjusting screws is preferably arranged in offset printing presses for quality job printing.

Such inking systems are known. They are embodied as dual rollers with an anilox and an application roller. They are sufficient for good newspaper quality. For the jobbing quality on coated paper with a seventy image screen, for example, anilox rollers with comparatively finer engraving than for newspaper printing are required for avoiding moiré effects. But rollers of that type are sensitive to mechanical damage.

In accordance with the invention a coarser, i.e. mechanically more stable, structure of the anilox roller can also be used for fine screens if the ink film of a coarse screen is smoothed on the application roller before the plate is touched.

Smoothing rollers with lateral distribution are known per se with classical inking systems. However, their diameter is kept small, they perform more than one revolution per length of print and reverse on the forme with their reversing points with lateral distribution.

This therefore results in stenciling, ink accumulations, in particular also from the print conduit of web-fed printing presses, and decrease in inking across the length of the circumference toward the end of printing.

It is proposed in a novel way to use only a single smoothing cylinder, which rotates 1:1 and can therefore not stencil on the circumference.

Falling into the application roller trough is prevented by bearer rings, and stopping in the trough by a gear wheel drive. With an endless vulcanized 1:1 application roller, the bearer rings and the gear wheel drive can be omitted. However, the greatest imprint quality can be achieved by means of offset print blankets as the ink transfer medium on the application roller cylinder, which requires a clamping groove or a vulcanized rubber blanket cylinder sleeve.

The smoothing cylinder is moved back and forth only once over two revolutions. During the first revolution it performs a forward movement over the entire print development of approximately 15 to 20 mm. The reversal of movement takes place in the cylinder groove of the application roller. During the second revolution the smoothing cylinder travels back—again over the entire print development length—without a movement reversal. Reversal again takes place in the cylinder trough. It is assured in this way that no differences in ink color because of stopping or movement reversal of the smoothing cylinder on the application roller, the plate, and therefore in the print image on the paper, become visible.

In every case the axial lift of the smoothing cylinder must be sufficiently large that a distance of more than one cup, or one hachure, on the screen roller is laterally distributed in the contact strip between the smoothing cylinder and the ink application roller.

The three roller inking system—i.e. a dual roller inking system with an additional 1:1-size smoothing roller—provides inking free of stencils to extremely difficult printing formes, along with satisfactory ink density over the width and the circumference.

In further development of the invention, the ink application roller can also work together with a double-size plate cylinder for two different ink plates on the circumference, for example, and therefore a cylinder ratio of 2:1 and more. In that case the application roller must be clocked in order to only ink its ink plate while it continues to remain in contact with the anilox roller. In this case the smoothing cylinder must follow the small position change of the application roller, i.e. the bearer ring is preserved by suitable means.

Exemplary embodiments of the invention are represented in the drawings and will be described in greater detail in what follows.

Shown are in:

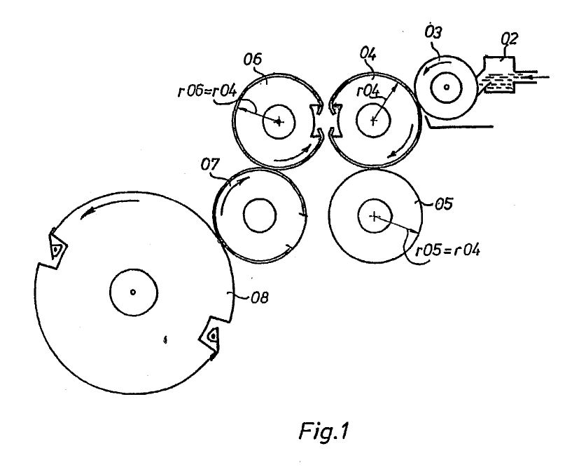

FIG. 1, a schematic representation of a print unit with a printing forme on the circumference of the forme cylinder,

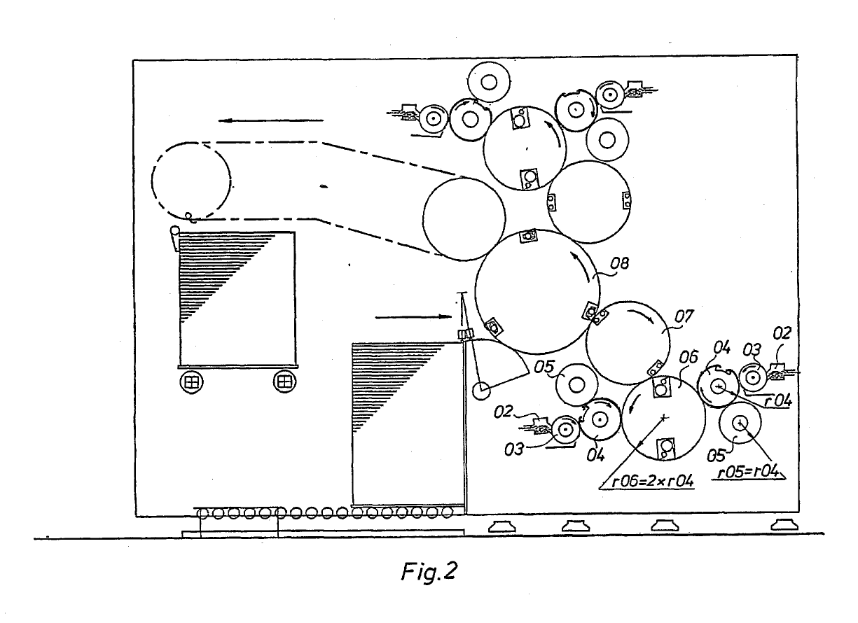

FIG. 2, a schematic representation of a printing press, wherein each forme cylinder has two printing formes, each of which is inked by an inking system.

An inking system of a rotary printing press, preferably an offset rotary printing press, substantially has a screen roller 04 (anilox roller), a first inking roller 04, for example an ink application roller 04, as well as a further inking roller 05, for example a smoothing cylinder 05. For supplying ink, a doctor blade device 02, for example a chamber doctor blade 02, is assigned to the screen roller 03. Preferably the ink is pasty and has a viscosity greater than 9000 Pa·s.

The ink application roller 04 inks a printing forme, for example the printing plate of a forme cylinder 06, for example a plate cylinder 06.

This forme cylinder 06 works together with a transfer cylinder 07, for example a rubber blanket cylinder 07. Together with a counter-pressure cylinder 08, this transfer cylinder 07 constitutes a printing location. The counter-pressure cylinder 08 can be embodied as a “hard” counter-pressure cylinder 08, for example with holding elements, or as a second transfer cylinder. An inking system can be assigned to the forme cylinder 06, in which case the radius r04 of the ink application roller 04 is identical to the radius r06 of the forme cylinder 06.

If several, for example two, inking systems are assigned to the forme cylinder 06, the number of inking systems is equal to the whole number multiple of the ratio of the radius r06 of the forme cylinder 06 to the radius r04 of the ink application roller 04 (FIG. 2).

The ink application roller 04 preferably touches the forme cylinder 06, as well as the screen roller 03. However, several inking rollers of the same size are possible between the screen roller 03 and the forme cylinder 06.

A further ink application roller 05, for example a smoothing roller 05, is assigned to this ink application roller 04.

The ink application roller 04 and/or the smoothing cylinder 05 perform a lift in the axial direction.

The smoothing cylinder 05 preferably performs traversing movements, and the ink application roller 04 is fixed in the axial direction.

List of Reference Symbols

01 —

02 Doctor blade device, chamber doctor blade

03 Screen roller

04 Ink application roller, inking roller

05 Smoothing cylinder, inking roller

06 Forme cylinder, plate cylinder

07 Transfer cylinder, rubber blanket cylinder

08 Counter-pressure cylinder

Radius r04

Radius r05

Radius r06

1. A short inking system of a rotary printing press, having a screen roller (03) and at least one ink application roller (04), which inks a forme cylinder (06), wherein the circumference of the forme cylinder (06) is a whole number multiple of a circumference of the ink application roller (04), wherein a smoothing cylinder (05), which performs a movement in the axial direction, is assigned to the ink application roller (04), characterized in that the ink application roller (04) and the smoothing cylinder (05) have identical diameters.

2. A short inking system of a rotary printing press, having a screen roller (03) and at least one ink application roller (04), which inks a forme cylinder (06), wherein the circumference of the forme cylinder (06) is a whole number multiple of a circumference of the ink application roller (04), characterized in that the ink application roller (04) is arranged in such a way that it performs a movement in the axial direction.

3. A short inking system of a rotary printing press, having a screen roller (03) and at least one ink application roller (04), wherein at least one inking roller (04) embodied as an ink application roller (04) is arranged so that it inks a forme cylinder (06), characterized in that over the length of one printing the inking roller (04, 05) performs a movement in one direction, and that the reversal of the movement direction takes place in a cylinder trough of the cooperating inking roller (04), or of the forme cylinder (06).

4. A short inking system of a rotary printing press, having a screen roller (03) and at least one ink application roller (04), which inks a forme cylinder (06), characterized in that ink application roller (04) and/or a smoothing cylinder (05) have an electric motor which is independent of the forme cylinder (06) and are electrically synchronized with the forme cylinder (06).

5. The short inking system in accordance with claim 2, 3 or 4, characterized in that at least one further inking roller (05) is arranged in addition to the ink application roller (04).

6. The short inking system in accordance with claim 5, characterized in that this further inking roller (05), embodied as a smoothing cylinder (05), is arranged to perform a movement in the axial direction.

7. The short inking system in accordance with claim 1, 2, 3 or 4, characterized in that a plurality of inking systems is assigned to the forme cylinder (06), and the number of these inking systems equals the whole number multiple of the circumference of the forme cylinder (06) in relation to the circumference of the ink application roller (04).

8. The short inking system in accordance with claim 1 or 6, characterized in that the forme cylinder (06), the ink application roller (04) and the smoothing cylinder (05) have equal diameters.

9. The short inking system in accordance with claim 1, 2, 3 or 4, characterized in that the ink application roller (04) has an offset rubber blanket for ink transfer.

10. The short inking system in accordance with claim 1 or 6, characterized in that the ink application roller (04), the smoothing cylinder (05) and the screen roller (02) with the forme cylinder (06) are forcibly synchronized by means of gear wheels.

11. The short inking system in accordance with claim 1, 2, 3 or 4, characterized in that the ink application roller (04) and the screen roller (03) have respectively cooperating bearing rings.

12. The short inking system in accordance with claim 1, 2, 3 or 4, characterized in that the ink application roller (04) and the screen roller (03) have bearing rings which act together in pairs.

13. The short inking system in accordance with claim 1, 2, 3 or 4, characterized in that a transfer cylinder (07) is arranged to act together with the forme cylinder (06).

14. The short inking system in accordance with claim 13, characterized in that the transfer cylinder (07) and forme cylinder (06) on the one hand, and the ink application roller (04) and the screen roller (03) on the other hand, have bearing rings which act together in pairs.

15. The short inking system in accordance with claim 11, 12 or 14, characterized in that the pairs of bearing rings are replaced by pretensed rolling bearings without bearing play.

16. The short inking system in accordance with claim 1, 2, 3 or 4, characterized in that the ink application roller (04) has a functionally endless blanket.

17. The short inking system in accordance with claim 16, characterized in that, with a vulcanized endless blanket on the ink application roller (04), no bearing rings are installed.

18. The short inking system in accordance with claim 1 or 6, characterized in that with two printing formes and inks on the circumference of the forme cylinder (06), the ink application roller (04), as well as the smoothing cylinder (05) only have half the circumference of the forme cylinder (06) and are clocked to ink only their assigned printing forme.

19. The short inking system in accordance with claim 1, 2, 3 or 4, characterized in that a chamber doctor blade (02) is assigned to the screen roller (03).

20. The short inking system in accordance with claim 1, 2, 3 or 4, characterized in that the screen roller (03) is arranged to work with pasty printing inks, in particular of a viscosity greater than 9000 mPa·s.

21. The short inking system in accordance with claim 1, 2, 3 or 4, characterized in that a ratio of a screen of the screen roller (03) to a ratio of a screen of the printing forme of the forme cylinder (06) is 0.5, in particular greater than 0.8.

22. The short inking system in accordance with claim 1, 2, 3 or 4, characterized in that a ratio of the circumferential length per angular unit of the traversing inking roller (04, 05) in relation to the lift per angular unit of the inking rollers (04, 05) is 2.5 to 5.
